(19) United States
(12) Patent Application Publication
(10) Pub. No.: US 2026/0262702 A1
(43) Pub. Date: Sep. 10, 2026

(54) DEVICE AND METHOD FOR WEAKENING A SHEET OF AEROSOL-GENERATING SUBSTRATE FOR AN AEROSOL-GENERATING ARTICLE COMPONENT

(71) Applicant: Philip Morris Products S.A., Neuchatel (CH)

(72) Inventor: Matteo BALBONI, Milano (IT)

(73) Assignee: Philip Morris Products S.A., Neuchatel (CH)

(21) Appl. No.: 19/167,694

(22) PCT Filed: Mar. 18, 2024
(86) PCT No.: PCT/EP2024/057176

§ 371 Date: Sep. 22, 2025

(30) Foreign Application Priority Data
Mar. 24, 2023 (EP) 23164096.2

(51) Int. Cl. A24C 5/01; A24B 3/14; A24B 15/14; A24B 15/16; A24C 5/28

(52) U.S. Cl. CPC A24C 5/01; A24B 3/14; A24B 15/14; A24B 15/16; A24C 5/28

(57) ABSTRACT

A device for weakening a sheet of aerosol-generating substrate for an aerosol-generating article component is provided, including: a first roller having a first rotation axis and first circumferential ridges on a first radial outer face delimiting respective first circumferential grooves on the first outer face, each first ridge having a circumferential recess forming a first interruption band on the first outer face; and a second roller having a second rotation axis and second circumferential ridges on a second radial outer face delimiting respective second circumferential grooves on the second outer face, each second ridge having a circumferential recess forming a second interruption band on the second outer face; the first and second rollers rotatable in opposite directions about the respective first and second axes, and at a coupling zone of the rollers, the first and second ridges are partially inserted in the second and first grooves, respectively.

The present disclosure relates to a device and a method for weakening a sheet of aerosol-generating substrate for an aerosol-generating article component.

Aerosol-generating articles such as heat-not-burn products in which an aerosol-generating substrate is heated rather than combusted, are known in the art. The aerosol-generating substrate is, for instance, a tobacco-free herbaceous or plant-based cast sheet or a biodegradable fiber-based material. Typically in such heated aerosol-generating articles, an aerosol is generated by the transfer of heat from a heat source to a physically separate aerosol-generating substrate or material, which may be located in contact with, within, around or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

In a typical manufacturing process of aerosol generating articles, an aerosol-generating substrate in a sheet or foil format goes through a crimping process. The crimped material is then gathered into a rod which is cut into parts. These cut rods are components of the aerosol generating articles.

The crimping process generally uses two rotating cylindrical rollers between which the sheet of material is pressed. These rollers have matching textured ridge-and-trough patterns on their outside surfaces that crimp the sheet through transversal stretching of substrate's fibers.

The crimping process is helpful for folding and gathering the sheet of aerosol-generating substrate into the rods that will fit into the aerosol generating articles. Indeed, the term “crimped sheet” denotes a sheet having a plurality of substantially parallel ridges or corrugations which are substantially parallel to the cylindrical axis of the rod. This facilitates folding and gathering of the crimped sheet of aerosol-generating substrate to form the rod.

The crimping process also influences, inter alia, the amount of air contact, the Resistance to Draw (RTD), and others, and, hence, is directly experienced by the users of the aerosol generating articles.

Document EP3609352B1 discloses an apparatus for crimping a sheet of tobacco material. The apparatus comprises a first and second facing crimping rollers defining a first and second rotation axis, respectively. The first roller includes a first plurality of circumferential ridges, wherein each of said first plurality of ridges is interrupted along its circumferential extension forming an interruption gap where, for a given interruption angle, an amplitude of the ridge differs from the ridge amplitude in the remaining circumferential extension of the ridge. The plurality of interruption gaps forms an interruption band defining a direction of extension which is angled with respect to a direction defined by the first rotation axis of an angle comprised between about 2° to about 25°. The plurality of interruption gaps allow to achieve less shredding occurrence and good tensile strength of the tobacco sheet.

It would be desirable to have a device and a method for weakening a sheet of aerosol-generating substrate for an aerosol-generating article component which further improve the quality of the sheet of aerosol-generating substrate and of the final aerosol-generating article.

It would be desirable to have a device and a method for weakening a sheet of aerosol-generating substrate for an aerosol-generating article allowing to speed up production rate and reliability of the machines.

It would be desirable to have a device and a method for weakening a sheet of aerosol-generating substrate for an aerosol-generating article component which is able to work on sheets of aerosol-generating substrate made of materials other than tobacco or reconstituted tobacco.

The present disclosure relates to a device for weakening a sheet of aerosol-generating substrate for an aerosol-generating article component. The device may comprise a first roller having a first rotation axis and comprising a plurality of first circumferential ridges provided on a first radial outer face of said first roller. The first circumferential ridges may delimit a respective plurality of first circumferential grooves on the first radial outer face. Each first circumferential ridge may have at least one circumferential recess and the circumferential recesses of the plurality of first circumferential ridges may form at least one first interruption band on the first radial outer face. The device may comprise a second roller having a second rotation axis and comprising a plurality of second circumferential ridges provided on a second radial outer face of said second roller. The second circumferential ridges may delimit a respective plurality of second circumferential grooves on the second radial outer face. Each second circumferential ridge may have at least one circumferential recess and the circumferential recesses of the plurality of second circumferential ridges may form at least one second interruption band on the second radial outer face. The first roller and the second roller may be configured to rotate in opposite directions about the respective first rotation axis and second rotation axis. At a coupling zone of the first roller with the second roller, the first circumferential ridges may be partially inserted in the second circumferential grooves and the second circumferential ridges may be partially inserted in the first circumferential grooves. The at least one first interruption band and the least one second interruption band, when facing each other at the coupling zone, may be crossed with respect to each other. Optionally, a motor is operatively connected to at least one of the first roller and the second roller. The motor may be configured to rotate the first roller and the second roller in the opposite directions.

The inventor found that the disclosed device avoids or reduce the tendency of the material of the sheet of aerosol-generating substrate to stick and settle on the rollers employed for weakening said sheet, for instance the rollers configured to crimp the sheet.

The inventor found that the disclosed device allows to reduce machine stops for cleaning operations of the rollers and/or the time required for each cleaning operation.

The inventor found that the disclosed device improves the quality of the final product, i.e. the aerosol-generating article, in terms of homogeneous aerosol-generating substrate.

The inventor found that the disclosed device avoids increasing the tensioning of the sheet and/or reducing the speed of the rollers, which would probably partially solve the stickiness problem but would cancel the weakening effect provided by the rollers, e.g. crimping effect, and may cause voids in the substrate.

The inventor found that the disclosed device avoids reducing the speed of the rollers, which would probably partially solve the stickiness problem but would lower productivity. Therefore, the disclosed device may run at the design speed.

The inventor found that the disclosed device allows to keep the design weakening depth, e.g. crimping depth, which would probably partially solve the stickiness problem but would reduce the weakening effect provided by the rollers, e.g. crimping effect.

A ratio of an area of the at least one first interruption band on the first radial outer face to an area of the first radial outer face provided with the plurality of first circumferential ridges and the plurality of first circumferential grooves may be between 0.03 and 0.30, optionally between 0.05 and 0.25, optionally 0.20.

For instance, the area of the at least one first interruption band on the first radial outer face is between 2000 mm² and 50000 mm², optionally between 2000 mm² and 10000 mm², optionally between 40000 mm² and 50000 mm². For instance, the area of the first radial outer face provided with the plurality of first circumferential ridges and the plurality of first circumferential grooves is between 170000 mm² and 180000 mm².

A ratio of an area of the at least one second interruption band on the second radial outer face to an area of the second radial outer face provided with the plurality of second circumferential ridges and the plurality of second circumferential grooves may be between 0.03 and 0.30, optionally between 0.05 and 0.25, optionally 0.20.

For instance, the area of the at least one second interruption band on the second radial outer face is between 2000 mm² and 50000 mm², optionally between 2000 mm² and 10000 mm², optionally between 40000 mm² and 50000 mm². For instance, the area of the second radial outer face provided with the plurality of second circumferential ridges and the plurality of second circumferential grooves is between 170000 mm² and 180000 mm².

The inventor found that the disclosed areas and ratios provide a good balance between weakening effects and stickiness-proof effects.

According to some embodiments, the at least one first interruption band is skew with respect to the first rotation axis. For instance, the at least one circumferential recess of one first circumferential ridge is circumferentially offset with respect to the at least one circumferential recess of two first circumferential ridges contiguous to the one first circumferential ridge to form the skew first interruption band.

Considering the first radial outer face flattened on a plane, the at least one first interruption band may delimit with the first rotation axis an angle (α) which may be between 2° and 25°.

According to some embodiments, the at least one second interruption band is skew with respect to the second rotation axis. For instance, the at least one circumferential recess of one second circumferential ridge is circumferentially offset with respect to the at least one circumferential recess of two second circumferential ridges contiguous to the one second circumferential ridge to form the skew second interruption band.

Considering the second radial outer face flattened on a plane, the at least one second interruption band may delimit with the second rotation axis an angle (α′) which may be between 2° and 25°.

According to some embodiments, the at least one first interruption band may be parallel to the first rotation axis. According to other embodiments, the at least one second interruption band may be parallel to the second rotation axis.

According to some embodiments, the at least one first interruption band and the at least one second interruption band are skewed concordantly, that is, in the same direction, optionally of a same angle (α=α′) or of a different angle (α≠α′).

According to some other embodiments, the at least one first interruption band and the at least one second interruption band are skewed discordantly, that is, in opposite directions, and of different angles (α≠α′).

A plurality of first interruption bands may be provided on the first radial outer face. For instance, each first circumferential ridge may have a plurality of circumferential recesses and the circumferential recesses of the plurality of first circumferential ridges form the plurality of first interruption bands on the first radial outer face. A number of the first interruption bands may be between 20 and 80.

According to some embodiments, the first interruption bands are circumferentially evenly spaced on the first radial outer face.

A plurality of second interruption bands may be provided on the second radial outer face. For instance, each second circumferential ridge may have a plurality of circumferential recesses and the circumferential recesses of the plurality of second circumferential ridges form the plurality of second interruption bands on the second radial outer face. A number of the second interruption bands may be between 20 and 80.

According to some embodiments, the second interruption bands are circumferentially evenly spaced on the second radial outer face.

At the coupling zone of the first roller with the second roller, each first interruption band may cross a plurality of second interruption bands and/or each second interruption band may cross a plurality of first interruption bands.

According to some embodiments, the first roller and the second roller are identical. The identical first roller and the second roller may be axially shifted to allow the first circumferential ridges to be partially inserted in the second circumferential grooves and the second circumferential ridges to be partially inserted in the first circumferential grooves.

For instance, shapes and sizes of the first circumferential ridges and of the first circumferential grooves may be identical to shapes and sizes of the second circumferential ridges and of the second circumferential grooves.

For instance, shapes and sizes of the at least one first interruption band may be identical to shapes and sizes of the least one second interruption band. For instance, shapes, sizes and number of the first interruption bands may be identical to shapes, sizes and number of the second interruption bands.

The inventor found that the identical rollers may help lowering costs of the device.

According to some embodiments, in a cross section including the first rotation axis, the first circumferential ridges and the first circumferential grooves may have wavy and rounded outlines.

According to some embodiments, in a cross section including the second rotation axis, the second circumferential ridges and the second circumferential grooves may have wavy and rounded outlines.

Optionally, in a cross section including the first rotation axis and the second rotation axis, the first circumferential ridges may have a shape complementary to a shape of the second circumferential grooves and the second circumferential ridges may have a shape complementary to a shape of the first circumferential grooves.

A ratio of an axial pitch (ap) of the first circumferential ridges to a thickness (t) of a sheet of aerosol-generating substrate and/or a ratio of an axial pitch (ap) of the second circumferential ridges to a thickness (t) of a sheet of aerosol-generating substrate may be between 2.0 and 20.0. A ratio of an axial pitch (ap) of the first circumferential ridges to a maximum diameter (D) of the first circumferential ridges and/or a ratio of an axial pitch (ap) of the second circumferential ridges to a maximum diameter (D) of the second circumferential ridges may be between 0.0017 and 0.05. An axial pitch (ap) of the first circumferential ridges and/or an axial pitch (ap) of the second circumferential ridges may be between 0.5 mm and 2.0 mm. A ratio of a height (h) of the first circumferential ridges to a thickness (t) of a sheet of aerosol-generating substrate and/or a ratio of a height (h) of the second circumferential ridges to a thickness (t) of a sheet of aerosol-generating substrate may be between 2.0 and 13.0. A ratio of a height (h) of the first circumferential ridges to a maximum diameter (D) of the first circumferential ridges and/or a ratio of a height (h) of the second circumferential ridges to a maximum diameter (D) of the second circumferential ridges may be between 0.0017 and 0.05. A height (h) of the first circumferential ridges and/or a height (h) of the second circumferential ridges may be between 0.5 mm and 2.0 mm. A ratio of a width (w) of the at least one first interruption band to a thickness (t) of a sheet of aerosol-generating substrate and/or a ratio of a width (w) of the at least one second interruption band to a thickness (t) of a sheet of aerosol-generating substrate may be between 8.0 and 70.0. A ratio of a width (w) of the at least one first interruption band to a maximum diameter (D) of the first circumferential ridges and/or a ratio of a width (w) of the at least one second interruption band to a maximum diameter (D) of the second circumferential ridges may be between 0.0067 and 0.25. A width (w) of the at least one first interruption band and/or a width (w) of the at least one second interruption band may be between 2.0 mm and 10.0 mm, optionally between 2.0 mm an 20.0 mm. A ratio of a circumferential pitch (cp) of the first interruption bands to a thickness (t) of a sheet of aerosol-generating substrate and/or a ratio of a circumferential pitch (cp) of the second interruption bands to a thickness (t) of a sheet of aerosol-generating substrate may be between 40 and 335. A ratio of a circumferential pitch (cp) of the first interruption bands to a maximum diameter (D) of the first circumferential ridges and/or a ratio of a circumferential pitch (cp) of the second interruption bands to a maximum diameter (D) of the second circumferential ridges may be between 0.033 and 1.25. A circumferential pitch (cp) of the at least one first interruption band and/or a circumferential pitch (cp) of the at least one second interruption band may be between 10.0 mm and 50.0 mm. A ratio of a curvature radius (r) of the first circumferential ridges to a thickness (t) of a sheet of aerosol-generating substrate and/or a ratio of a curvature radius (r) of the second circumferential ridges to a thickness (t) of a sheet of aerosol-generating substrate may be between 0.4 and 3.33. A ratio of a curvature radius (r) of the first circumferential ridges to a maximum diameter (D) of the first circumferential ridges and/or a ratio of a curvature radius (r) of the second circumferential ridges to a maximum diameter (D) of the second circumferential ridges may be between 0.0003 and 0.0125. A curvature radius (r) of the first circumferential ridges and/or a curvature radius (r) of the second circumferential ridges may be between 0.1 mm and 0.5 mm. A ratio of a width (A) of a sheet of aerosol-generating substrate to an axial length (L) of the first roller and/or a ratio of a width (A) of a sheet of aerosol-generating substrate to an axial length (L) of the second roller may be between 0.25 and 0.95. An axial length (L) of the first roller and/or an axial length (L) of the second roller may be between 80 mm and 400 mm. A maximum diameter (D) of the first circumferential ridges and/or a maximum diameter (D) of the second circumferential ridges may be between 40 mm and 300 mm. A tapering angle (p) of each first circumferential ridge and/or a tapering angle (p) of each second circumferential ridge may be between 15° and 65°. A width (A) of a sheet of aerosol-generating substrate may be between 80 mm and 250 mm. A thickness (t) of the sheet of aerosol-generating substrate may be between 0.15 mm and 0.25 mm.

The present disclosure also relates to a method for weakening a sheet of aerosol-generating substrate for an aerosol-generating article component.

The method comprises: feeding a sheet of aerosol-generating substrate between the first roller and the second roller of a device for weakening a sheet of aerosol-generating substrate for an aerosol-generating article component while the first roller and the second roller rotate in opposite directions.

The device may be the one disclosed above or may have one or more of the device features disclosed above.

The device may comprise a first roller having a first rotation axis and comprising a plurality of first circumferential ridges provided on a first radial outer face of said first roller. The first circumferential ridges may delimit a respective plurality of first circumferential grooves on the first radial outer face. Each first circumferential ridge may have at least one circumferential recess and the circumferential recesses of the plurality of first circumferential ridges may form at least one first interruption band on the first radial outer face. The device may comprise a second roller having a second rotation axis and comprising a plurality of second circumferential ridges provided on a second radial outer face of said second roller. The second circumferential ridges may delimit a respective plurality of second circumferential grooves on the second radial outer face. Each second circumferential ridge may have at least one circumferential recess and the circumferential recesses of the plurality of second circumferential ridges may form at least one second interruption band on the second radial outer face. The first roller and the second roller may be configured to rotate in opposite directions about the respective first rotation axis and second rotation axis. At a coupling zone of the first roller with the second roller, the first circumferential ridges may be partially inserted in the second circumferential grooves and the second circumferential ridges may be partially inserted in the first circumferential grooves. The at least one first interruption band and the least one second interruption band, when facing each other at the coupling zone, may be crossed with respect to each other. Optionally, a motor is operatively connected to at least one of the first roller and the second roller. The motor may be configured to rotate the first roller and the second roller in the opposite directions.

The inventor found that, as stated above for the device, the disclosed method positively affects the quality of the sheet of aerosol-generating substrate and of the final aerosol-generating article and the productivity and reliability of the apparatuses for manufacturing aerosol-generating article components and articles.

According to some embodiments, the sheet of aerosol-generating substrate is a fiber-based substrate. For instance, the sheet of aerosol-generating substrate is made from a cellulose mixture and said mixture may comprise: fibers, a binder and an aerosol forming agent. The fibers may be cellulose fibers. The binder may comprise a derivative of cellulose, for instance carboxymethylcellulose and hydroxypropylmethylcellulose. The aerosol forming agent may be a polyhydric alcohol, for instance triethylene glycol or 1,3-butanediol or glycerine.

An amount of the fibers in the mixture may be 15.0 percent to 20.0 percent on dry weight basis. An amount of the binder in the mixture may be 28.0 percent to 30.0 percent on dry weight basis. An amount of the aerosol forming agent in the mixture may be 45.0 percent to 55.0 percent on dry weight basis. For instance, an amount of the carboxymethylcellulose in the mixture is 5.0 percent to 6.0 percent on dry weight basis. For instance, an amount of the hydroxypropylmethylcellulose in the mixture is 21.0 percent to 24.0 percent on dry weight basis. The mixture may also comprises nicotine and fumaric acid. An amount of the nicotine in the mixture may be 1.0 percent to 2.0 percent on dry weight basis. An amount of the fumaric acid in the mixture may be 1.5 percent to 2.0 percent on dry weight basis.

According to some embodiments, the sheet of aerosol-generating substrate has an elongation at break in longitudinal direction between 5.0 mm and 7.5 mm, optionally between 5.5 mm and 7.0 mm. The sheet of aerosol-generating substrate may have an elongation at break in cross direction between 9.5 mm and 12.5 mm, optionally between 10.0 mm and 12.0 mm.

The sheet of aerosol-generating substrate may have a Young's module in cross direction between 0.8 N/mm and 1.2 N/mm, optionally between 0.9 N/mm and 1.1 N/mm. The sheet of aerosol-generating substrate may have a Young's module in longitudinal direction between 5 N/mm and 7 N/mm, optionally between 5.5 N/mm and 6.5 N/mm.

The sheet of aerosol-generating substrate may have a thickness (t) between 0.15 mm and 0.25 mm. The sheet of aerosol-generating substrate may have a grammage between 100 g/m² and 160 g/m². The sheet of aerosol-generating substrate may have a humidity between 5 percent and 10 percent. The sheet of aerosol-generating substrate may have a stickiness between 0.0150 N and 0.0165 N. The sheet of aerosol-generating substrate may have a width (A) between 80 mm and 250 mm.

The inventor found that the device and method above disclosed are particularly effective when used in combination with sheet of aerosol-generating substrate provided with one or more of the properties disclosed above. Indeed, the elastic behaviour of this kind of sheet is such that, when stickiness occurs, a high force is required to cause the detaching from the rollers and the sheet does not break immediately. This results in rollers running at not optimal conditions for long times when this kind of sheet is processed.

Furthermore, stickiness proved to greatly affect this kind of sheet due to the high pressure force applied during crimping process, since this kind of sheet proves to be low sensitive to crimping due to its elasticity, resulting in high stickiness effect during crimping process.

According to other embodiments, the sheet of aerosol-generating substrate is a cast leaf, such as tobacco cast leaf. The cast leaf may be obtained through a casting process from ingredients such as tobacco powder or other nicotine containing materials, water, fibers, for instance cellulose, glycerin, guar. A first step may be the manufacturing of a tobacco slurry by mixing the above ingredients. The slurry is a watery mixture of insoluble matter with a high water content, for instance of 70 percent-80 percent. In a second step, the slurry may be put inside a casting box to be casted by a casting knife on a moving conveyor to create a continuous sheet.

The present disclosure also relates to a weakened sheet of aerosol-generating substrate.

According to some embodiments, the weakened sheet of aerosol-generating substrate is weakened through the device disclosed above and/or through the method disclosed above.

The weakened sheet of aerosol-generating substrate may have weakened portions and un-weakened bands, the un-weakened bands crossing each other.

The un-weakened bands may be created by the at least one first interruption band and by the at least one second interruption band of the device.

The weakened portions may be created by areas of the first radial outer face provided with the plurality of first circumferential ridges and the plurality of first circumferential grooves and by areas of the second radial outer face provided with the plurality of second circumferential ridges and the plurality of second circumferential grooves.

According to some embodiments, the weakened portions are crimped portions and the un-weakened bands are un-crimped portions.

The present disclosure also relates to a process for manufacturing an aerosol-generating article component, wherein the process comprises the method above disclosed.

The process may comprise the following steps:
manufacturing a sheet of aerosol-generating substrate;
weakening the sheet of aerosol-generating substrate through the method disclosed above;
gathering the sheet of aerosol-generating substrate to form a continuous rod;
cutting the continuous rod into a plurality of aerosol-generating article components each having a rod shape, each aerosol-generating article component comprising a gathered weakened sheet formed from a cut portion of the weakened sheet of aerosol-generating substrate.

According to some embodiments, the weakened sheet of aerosol-generating substrate is a fiber-based substrate. For instance, the weakened sheet of aerosol-generating substrate is made from a cellulose mixture and said mixture may comprise: fibers, a binder and an aerosol forming agent. The fibers may be cellulose fibers. The binder may comprise a derivative of cellulose, for instance carboxymethylcellulose and hydroxypropylmethylcellulose. The aerosol forming agent may be a polyhydric alcohol, for instance triethylene glycol or 1,3-butanediol or glycerine. The substrate may be made from a tobacco-free cellulose mixture.

An amount of the fibers in the mixture may be 15.0 percent to 20.0 percent on dry weight basis. An amount of the binder in the mixture may be 28.0 percent to 30.0 percent on dry weight basis. An amount of the aerosol forming agent in the mixture may be 45.0 percent to 55.0 percent on dry weight basis. For instance, an amount of the carboxymethylcellulose in the mixture is 5.0 percent to 6.0 percent on dry weight basis. For instance, an amount of the hydroxypropylmethylcellulose in the mixture is 21.0 percent to 24.0 percent on dry weight basis. The mixture may also comprises nicotine and fumaric acid. An amount of the nicotine in the mixture may be 1.0 percent to 2.0 percent on dry weight basis. An amount of the fumaric acid in the mixture may be 1.5 percent to 2.0 percent on dry weight basis.

According to some embodiments, the sheet of aerosol-generating substrate, before weakening, has an elongation at break in longitudinal direction between 5.0 mm and 7.5 mm, optionally between 5.5 mm and 7.0 mm. The sheet of aerosol-generating substrate, before weakening, may have an elongation at break in cross direction between 9.5 mm and 12.5 mm, optionally between 10.0 mm and 12.0 mm.

The sheet of aerosol-generating substrate, before weakening, may have a Young's module in cross direction between 0.8 N/mm and 1.2 N/mm, optionally between 0.9 N/mm and 1.1 N/mm. The sheet of aerosol-generating substrate, before weakening, may have a Young's module in longitudinal direction between 5 N/mm and 7 N/mm, optionally between 5.5 N/mm and 6.5 N/mm.

The sheet of aerosol-generating substrate, before weakening, may have a thickness (t) between 0.15 mm and 0.25 mm. The sheet of aerosol-generating substrate, before weakening, may have a grammage between 100 g/m² and 160 g/m². The sheet of aerosol-generating substrate, before weakening, may have a humidity between 5 percent and 10 percent. The sheet of aerosol-generating substrate, before weakening, may have a stickiness between 0.0150 N and 0.0165 N. The sheet of aerosol-generating substrate, before weakening, may have a width (A) between 80 mm and 250 mm.

According to other embodiments, the sheet of aerosol-generating substrate is a cast leaf, such as tobacco cast leaf. The cast leaf may be obtained through a casting process from ingredients such as tobacco powder or other nicotine containing materials, water, fibers, for instance cellulose, glycerin, guar. A first step may be the manufacturing of a tobacco slurry by mixing the above ingredients. The slurry is a watery mixture of insoluble matter with a high water content, for instance of 70 percent-80 percent. In a second step, the slurry may be put inside a casting box to be casted by a casting knife on a moving conveyor to create a continuous sheet.

The present disclosure also relates to an apparatus for manufacturing aerosol-generating article components, the apparatus comprising the device for weakening a sheet of aerosol-generating substrate for an aerosol-generating article component disclosed above.

The present disclosure also relates to an aerosol-generating article comprising at least one aerosol-generating article component made according to the process for manufacturing an aerosol-generating article component disclosed above.

As used in the present description, the coupling zone of the first roller with the second roller is the portion of the first roller and of the second roller intermeshing with each other where the first circumferential ridges of the first roller are at least partially inserted in the second circumferential grooves of the second roller and the second circumferential ridges of the second roller are at least partially inserted in the first circumferential grooves of the first roller.

As used in the present description, the axial length or distance is a distance measured parallel to the first and second rotation axes.

As used in the present description, the radial height or distance is a distance measured perpendicular to the first and second rotation axes.

As used in the present description, the term circumferential refers to a circumference centred on the first rotation axis or on the second rotation axis.

As used in the present description, the top portions of the first circumferential ridges and the top portions of the second circumferential ridges are radially outermost surfaces of said circumferential ridges, i.e. the surfaces of said circumferential ridges furthest from the respective first or second rotation axis.

As used in the present description, the bottoms of the first circumferential grooves and the bottoms of the second circumferential grooves are radially innermost surfaces of said circumferential grooves, i.e. the surfaces of said circumferential grooves closest to the respective first or second rotation axis.

As used in the present description, the circumferential recesses in the first circumferential ridges or in the second circumferential ridges are portions of the first circumferential ridges or of the second circumferential ridges having a radial height less than a radial eight of the respective top portions (less corrugated). Said circumferential recesses may also be flush with the bottoms of the first circumferential grooves or the bottoms of the second circumferential grooves (un-corrugated).

The invention is defined in the claims. However, below there is provided a non-exhaustive list of non-limiting examples. Any one or more of the features of these examples may be combined with any one or more features of another example, embodiment, or aspect described herein.

EX1. A device for weakening a sheet of aerosol-generating substrate for an aerosol-generating article component, the device comprising:
a first roller having a first rotation axis and comprising a plurality of first circumferential ridges provided on a first radial outer face of said first roller, the first circumferential ridges delimiting a respective plurality of first circumferential grooves on the first radial outer face; wherein each first circumferential ridge has at least one circumferential recess and the circumferential recesses of the plurality of first circumferential ridges form at least one first interruption band on the first radial outer face;
a second roller having a second rotation axis and comprising a plurality of second circumferential ridges provided on a second radial outer face of said second roller, the second circumferential ridges delimiting a respective plurality of second circumferential grooves on the second radial outer face; wherein each second circumferential ridge has at least one circumferential recess and the circumferential recesses of the plurality of second circumferential ridges form at least one second interruption band on the second radial outer face;
the first roller and the second roller are configured to rotate in opposite directions about the respective first rotation axis and second rotation axis;
wherein, at a coupling zone of the first roller with the second roller, the first circumferential ridges are partially inserted in the second circumferential grooves and the second circumferential ridges are partially inserted in the first circumferential grooves;
wherein, the at least one first interruption band and the least one second interruption band, when facing each other at the coupling zone, are crossed with respect to each other;
optionally a motor is operatively connected to at least one of the first roller and the second roller and is configured to rotate the first roller and the second roller in the opposite directions.

EX2. A method for weakening a sheet of aerosol-generating substrate for an aerosol-generating article component, the method comprising: feeding a sheet of aerosol-generating substrate between the first roller and the second roller of the device according to EX1 while the first roller and the second roller rotate in opposite directions.

EX3. A process for manufacturing an aerosol-generating article component, the process comprising the following steps:
manufacturing a sheet of aerosol-generating substrate;
weakening the sheet of aerosol-generating substrate through the method of EX2;
gathering the sheet of aerosol-generating substrate to form a continuous rod;
cutting the continuous rod into a plurality of aerosol-generating article components each having a rod shape, each aerosol-generating article component comprising a gathered weakened sheet formed from a cut portion of the weakened sheet of aerosol-generating substrate.

EX4. An aerosol-generating article comprising at least one aerosol-generating article component made according to the process of EX3.

EX5. An apparatus for manufacturing aerosol-generating article components, the apparatus comprising the device of EX1.

EX6. The device according to EX1, wherein a ratio of an area of the at least one first interruption band on the first radial outer face to an area of the first radial outer face provided with the plurality of first circumferential ridges and the plurality of first circumferential grooves is between 0.03 and 0.30, optionally between 0.05 and 0.25, optionally 0.20.

EX7. The device according to EX1 or EX6, wherein an area of the at least one first interruption band on the first radial outer face is between 2000 mm² and 50000 mm², optionally between 2000 mm² and 10000 mm², optionally between 40000 mm² and 50000 mm.

EX8. The device according to EX1 or EX6 or EX7, wherein a ratio of an area of the at least one second interruption band on the second radial outer face to an area of the second radial outer face provided with the plurality of second circumferential ridges and the plurality of second circumferential grooves is between 0.03 and 0.30, optionally between 0.05 and 0.25, optionally 0.20.

EX9. The device according to EX1 or to any of EX6 to EX8, wherein an area of the at least one second interruption band on the second radial outer face is between 2000 mm² and 50000 mm², optionally between 2000 mm² and 10000 mm², optionally between 40000 mm² and 50000 mm².

EX10. The device according to EX1 or to any of EX6 to EX9, wherein the at least one first interruption band is skew with respect to the first rotation axis.

EX11. The device according to EX1 or to any of EX6 to EX10, wherein the at least one circumferential recess of one first circumferential ridge is circumferentially offset with respect to the at least one circumferential recess of two first circumferential ridges contiguous to the one first circumferential ridge to form the skew first interruption band.

EX12. The device according to EX1 or to any of EX6 to EX11, wherein, considering the first radial outer face flattened on a plane, the at least one first interruption band delimits with the first rotation axis an angle (α) between 2° and 25°.

EX13. The device according to EX1 or to any of EX6 to EX12, wherein the at least one second interruption band is skew with respect to the second rotation axis.

EX14. The device according to EX1 or to any of EX6 to EX13, wherein the at least one circumferential recess of one second circumferential ridge is circumferentially offset with respect to the at least one circumferential recess of two second circumferential ridges contiguous to the one second circumferential ridge to form the skew second interruption band.

EX15. The device according to EX1 or to any of EX6 to EX14, wherein, considering the second radial outer face flattened on a plane, the at least one second interruption band delimits with the second rotation axis an angle (α′) between 2° and 25°.

EX16. The device according to EX1 or to any of EX6 to EX15, wherein each first circumferential ridge has a plurality of circumferential recesses and the circumferential recesses of the plurality of first circumferential ridges form a plurality of first interruption bands on the first radial outer face.

EX17. The device according to EX16, wherein the first interruption bands are circumferentially evenly spaced on the first radial outer face.

EX18. The device according to EX16 or E17, wherein a number of the first interruption bands is between 20 and 80.

EX19. The device according to EX1 or to any of EX6 to EX18, wherein each second circumferential ridge has a plurality of circumferential recesses and the circumferential recesses of the plurality of second circumferential ridges form a plurality of second interruption bands on the second radial outer face.

EX20. The device according to EX19, wherein the second interruption bands are circumferentially evenly spaced on the second radial outer face.

EX21. The device according to EX19 or EX20, wherein a number of the second interruption bands is between 20 and 80.

EX22. The device according to any of EX16 to EX21, wherein, at the coupling zone of the first roller with the second roller, each first interruption band crosses a plurality of second interruption bands.

EX23. The device according to any of EX16 to EX22, wherein, at the coupling zone of the first roller with the second roller, each second interruption band crosses a plurality of first interruption bands.

EX24. The device according to EX1 or to any of EX6 to EX23, wherein the least one first interruption band is parallel to the first rotation axis.

EX25. The device according to EX1 or to any of EX6 to EX23, wherein the at least one second interruption band is parallel to the second rotation axis.

EX26. The device according to EX1 or to any of EX6 to EX25, wherein the first roller and the second roller are identical and axially shifted to allow the first circumferential ridges to be partially inserted in the second circumferential grooves and the second circumferential ridges to be partially inserted in the first circumferential grooves.

EX27. The device according to EX1 or to any of EX6 to EX26, wherein shapes and sizes of the first circumferential ridges and of the first circumferential grooves are identical to shapes and sizes of the second circumferential ridges and of the second circumferential grooves.

EX28. The device according to EX1 or to any of EX6 to EX27, wherein shapes and sizes of the at least one first interruption band are identical to shapes and sizes of the least one second interruption band.

EX29. The device according to any of EX16 to EX23, wherein shapes, sizes and number of the first interruption bands are identical to shapes, sizes and number of the second interruption bands.

EX30. The device according to EX1 or to any of EX6 to EX29, wherein in a cross section including the first rotation axis, the first circumferential ridges and the first circumferential grooves have wavy and rounded outlines.

EX31. The device according to EX1 or to any of EX6 to EX30, wherein in a cross section including the second rotation axis, the second circumferential ridges and the second circumferential grooves have wavy and rounded outlines.

EX32. The device according to EX1 or to any of EX6 to EX31, wherein, in a cross section including the first rotation axis and the second rotation axis, the first circumferential ridges have a shape complementary to a shape of the second circumferential grooves and the second circumferential ridges have a shape complementary to a shape of the first circumferential grooves.

EX33. The device according to EX1 or to any of EX6 to EX32, wherein a ratio of an axial pitch (ap) of the first circumferential ridges to a thickness (t) of a sheet of aerosol-generating substrate is between 2.0 and 20.0.

EX34. The device according to EX1 or to any of EX6 to EX33, wherein a ratio of an axial pitch (ap) of the second circumferential ridges to a thickness (t) of a sheet of aerosol-generating substrate is between 2.0 and 20.0.

EX35. The device according to EX1 or to any of EX6 to EX34, wherein a ratio of an axial pitch (ap) of the first circumferential ridges to a maximum diameter (D) of the first circumferential ridges is between 0.0017 and 0.05.

EX36. The device according to EX1 or to any of EX6 to EX35, wherein a ratio of an axial pitch (ap) of the second circumferential ridges to a maximum diameter (D) of the second circumferential ridges is between 0.0017 and 0.05.

EX37. The device according to EX1 or to any of EX6 to EX36, wherein an axial pitch (ap) of the first circumferential ridges is between 0.5 mm and 3.0 mm.

EX38. The device according to EX1 or to any of EX6 to EX37, an axial pitch (ap) of the second circumferential ridges is between 0.5 mm and 3.0 mm.

EX39. The device according to EX1 or to any of EX6 to EX38, wherein a ratio of a height (h) of the first circumferential ridges to a thickness (t) of a sheet of aerosol-generating substrate is between 2.0 and 13.0.

EX40. The device according to EX1 or to any of EX6 to EX39, wherein a ratio of a height (h) of the second circumferential ridges to a thickness (t) of a sheet of aerosol-generating substrate is between 2.0 and 13.0.

EX41. The apparatus according to EX1 or to any of EX6 to EX40, wherein a ratio of a height (h) of the first circumferential ridges to a maximum diameter (D) of the first circumferential ridges is between 0.0017 and 0.05.

EX42. The device according to EX1 or to any of EX6 to EX41, wherein a ratio of a height (h) of the second circumferential ridges to a maximum diameter (D) of the second circumferential ridges is between 0.0017 and 0.05.

EX43. The device according to EX1 or to any of EX6 to EX42, wherein a height (h) of the first circumferential ridges is between 0.5 mm and 2.0 mm.

EX44. The device according to EX1 or to any of EX6 to EX43, wherein a height (h) of the second circumferential ridges is between 0.5 mm and 2.0 mm.

EX45. The device according to EX1 or to any of EX6 to EX44, wherein a ratio of a width (w) of the at least one first interruption band to a thickness (t) of a sheet of aerosol-generating substrate is between 8.0 and 70.0.

EX46. The device according to EX1 or to any of EX6 to EX45, wherein a ratio of a width (w) of the at least one second interruption band to a thickness (t) of a sheet of aerosol-generating substrate is between 8.0 and 70.0.

EX47. The device according to EX1 or to any of EX6 to EX46, a ratio of a width (w) of the at least one first interruption band to a maximum diameter (D) of the first circumferential ridges is between 0.0067 and 0.25.

EX48. The device according to EX1 or to any of EX6 to EX47, a ratio of a width (w) of the at least one second interruption band to a maximum diameter (D) of the second circumferential ridges is between 0.0067 and 0.25.

EX49. The device according to EX1 or to any of EX6 to EX48, wherein a width (w) of the at least one first interruption band is between 2.0 mm and 10.0 mm, optionally between 2.0 mm an 20.0 mm.

EX50. The device according to EX1 or to any of EX6 to EX49, wherein a width (w) of the at least one second interruption band is between 2.0 mm and 10.0 mm, optionally between 2.0 mm an 20.0 mm.

EX51. The device according to EX1 or to any of EX6 to EX50, wherein a ratio of a circumferential pitch (cp) of the first interruption bands to a thickness (t) of a sheet of aerosol-generating substrate is between 40 and 335.

EX52. The device according to EX1 or to any of EX6 to EX51, wherein a ratio of a circumferential pitch (cp) of the second interruption bands to a thickness (t) of a sheet of aerosol-generating substrate is between 40 and 335.

EX53. The device according to EX1 or to any of EX6 to EX52, wherein a ratio of a circumferential pitch (cp) of the first interruption bands to a maximum diameter (D) of the first circumferential ridges is between 0.033 and 1.25.

EX54. The device according to EX1 or to any of EX6 to EX53, wherein a ratio of a circumferential pitch (cp) of the second interruption bands to a maximum diameter (D) of the second circumferential ridges is between 0.033 and 1.25.

EX55. The device according to EX1 or to any of EX6 to EX54, wherein a circumferential pitch (cp) of the at least one first interruption band is between 10.0 mm and 50.0 mm.

EX56. The device according to EX1 or to any of EX6 to EX55, wherein a circumferential pitch (cp) of the at least one second interruption band is between 10.0 mm and 50.0 mm.

EX57. The device according EX1 or to any of EX6 to EX56, wherein a ratio of a curvature radius (r) of the first circumferential ridges to a thickness (t) of a sheet of aerosol-generating substrate is between 0.4 and 3.33.

EX58. The article according EX1 or to any of EX6 to EX57, wherein a ratio of a curvature radius (r) of the second circumferential ridges to a thickness (t) of a sheet of aerosol-generating substrate is between 0.4 and 3.33.

EX59. The device according EX1 or to any of EX6 to EX58, wherein a ratio of a curvature radius (r) of the first circumferential ridges to a maximum diameter (D) of the first circumferential ridges is between 0.0003 and 0.0125.

EX60. The device according EX1 or to any of EX6 to EX59, wherein a ratio of a curvature radius (r) of the second circumferential ridges to a maximum diameter (D) of the second circumferential ridges is between 0.0003 and 0.0125.

EX61. The device according EX1 or to any of EX6 to EX60, wherein a curvature radius (r) of the first circumferential ridges is between 0.1 mm and 0.5 mm.

EX62. The device according EX1 or to any of EX6 to EX61, wherein a curvature radius (r) of the second circumferential ridges is between 0.1 mm and 0.5 mm.

EX63. The device according EX1 or to any of EX6 to EX62, wherein a ratio of a width (A) of a sheet of aerosol-generating substrate to an axial length (L) of the first roller is between 0.2 and 0.95.

EX64. The device according EX1 or to any of EX6 to EX63, wherein a ratio of a width (A) of a sheet of aerosol-generating substrate to an axial length (L) of the second roller is between 0.25 and 0.95.

EX65. The device according EX1 or to any of EX6 to EX64, wherein a width (A) of a sheet of aerosol-generating substrate is between 80 mm and 250 mm.

EX66. The device according EX1 or to any of EX6 to EX65, wherein an axial length (L) of the first roller is between 80 mm and 400 mm.

EX67. The device according EX1 or to any of EX6 to EX66, wherein an axial length (L) of the second roller is between 80 mm and 400 mm.

EX68. The device according EX1 or to any of EX6 to EX67, wherein a thickness (t) of the sheet of aerosol-generating substrate is between 0.15 mm and 0.25 mm.

EX69. The device according EX1 or to any of EX6 to EX68, wherein a maximum diameter (D) of the first circumferential ridges is between 40 mm and 300 mm.

EX70. The device according EX1 or to any of EX6 to EX69, wherein a maximum diameter (D) of the second circumferential ridges is between 40 mm and 300 mm.

EX71. The device according EX1 or to any of EX6 to EX70, wherein a tapering angle (p) of each first circumferential ridge is between 15° and 65°.

EX72. The device according EX1 or to any of EX6 to EX71, wherein a tapering angle (p) of each second circumferential ridge is between 15° and 65°.

EX73. The device according EX1 or to any of EX6 to EX72 or the method according to EX2, wherein the sheet of aerosol-generating substrate is a fiber-based substrate.

EX74. The device according EX1 or to any of EX6 to EX73 or the method according to EX2 or EX72, wherein the sheet of aerosol-generating substrate is made from a cellulose mixture.

EX75. The device according EX1 or to any of EX6 to EX74 or the method according to EX2 or EX72 or EX73, wherein the sheet of aerosol-generating substrate is made from a mixture comprising: fibers, a binder and an aerosol forming agent.

EX76. The device or the method according EX75, wherein the fibers are cellulose fibers, wherein the binder comprises a derivative of cellulose, wherein the aerosol forming agent is a polyhydric alcohol.

EX77. The device or the method according EX75 or EX76, wherein an amount of the fibers in the mixture is 15.0 percent to 20.0 percent on dry weight basis.

EX78. The device or the method according any of EX75 to EX77, wherein an amount of the binder in the mixture is 28.0 percent to 30.0 percent on dry weight basis.

EX79. The device or the method according to any of EX75 to EX78, wherein an amount of the aerosol forming agent in the mixture is 45.0 percent to 55.0 percent on dry weight basis.

EX80. The device or the method according to EX76 or to any of EX77 to EX79 when according to EX76, wherein the derivative of cellulose comprises carboxymethylcellulose and hydroxypropylmethylcellulose.

EX81. The device or the method according to EX80, wherein an amount of the carboxymethylcellulose in the mixture is 5.0 percent to 6.0 percent on dry weight basis.

EX82. The device or the method according to EX80 or EX81, wherein an amount of the hydroxypropylmethylcellulose in the mixture is 21.0 percent to 24.0 percent on dry weight basis.

EX83. The device or the method according to EX76 or to any of EX77 to EX79 when according to EX76, wherein the polyhydric alcohol is triethylene glycol, 1,3-butanediol or glycerine.

EX84. The device or the method according to any of EX75 to EX83, wherein the mixture further comprises nicotine and fumaric acid.

EX85. The device or the method according to EX84, wherein an amount of the nicotine in the mixture is 1.0 percent to 2.0 percent on dry weight basis.

EX86. The device or the method according to EX84 or EX85, wherein an amount of the fumaric acid in the mixture is 1.5 percent to 2.0 percent on dry weight basis.

EX87. The device according EX1 or to any of EX6 to EX86 or the method according to EX2 or the device or the method according to any of EX73 to EX86, wherein the sheet of aerosol-generating substrate has an elongation at break in longitudinal direction between 5.0 mm and 7.5 mm.

EX88. The device or the method according to EX87, wherein the sheet of aerosol-generating substrate has an elongation at break in longitudinal direction between 5.5 mm and 7.0 mm.

EX89. The device according EX1 or to any of EX6 to EX88 or the method according to EX2 or to any of EX73 to EX88, wherein the sheet of aerosol-generating substrate has an elongation at break in cross direction between 9.5 mm and 12.5 mm.

EX90. The device or the method according to EX89, wherein the sheet of aerosol-generating substrate has an elongation at break in cross direction between 10.0 mm and 12.0 mm.

EX91. The device according EX1 or to any of EX6 to EX90 or the method according to EX2 or to any of EX73 to EX90, wherein the sheet of aerosol-generating substrate has a Young's module in cross direction between 0.8 N/mm and 1.2 N/mm.

EX92. The device or the method according to EX91, wherein the sheet of aerosol-generating substrate has a Young's module in cross direction between 0.9 N/mm and 1.1 N/mm.

EX93. The device according EX1 or to any of EX6 to EX92 or the method according to EX2 or to any of EX73 to EX92, wherein the sheet of aerosol-generating substrate has a Young's module in longitudinal direction between 5 N/mm and 7 N/mm.

EX94. The device or the method according to EX93, wherein the sheet of aerosol-generating substrate has a Young's module in longitudinal direction between 5.5 N/mm and 6.5 N/mm.

EX95. The device according EX1 or to any of EX6 to EX94 or the method according to EX2 or according to any of EX73 to EX94, wherein the sheet of aerosol-generating substrate has a thickness (t) between 0.15 mm and 0.25 mm.

EX96. The device according EX1 or to any of EX6 to EX95 or the method according to EX2 or according to any of EX73 to EX95, wherein the sheet of aerosol-generating substrate has a width (A) between 80 mm and 250 mm.

EX97. The device according EX1 or to any of EX6 to EX96 or the method according to EX2 or according to any of EX73 to EX96, wherein the sheet of aerosol-generating substrate has a grammage between 100 g/m² and 160 g/m².

EX98. The device according EX1 or to any of EX6 to EX97 or the method according to EX2 or according to any of EX73 to EX97, wherein the sheet of aerosol-generating substrate has a humidity between 5 percent and 10 percent.

EX99. The device according EX1 or to any of EX6 to EX98 or the method according to EX2 or according to any of EX73 to EX98, wherein the sheet of aerosol-generating substrate has stickiness between 0.0150 N and 0.0165 N.

EX100. The device according EX1 or to any of EX6 to EX72 or the method according to EX2, wherein the sheet of aerosol-generating substrate is a tobacco cast leaf.

EX101. The device or the method according EX100, wherein the tobacco cast leaf is obtained by mixing tobacco powder, water, fibers and an aerosol former, for instance glycerin, to obtain a tobacco slurry.

EX102. The device or the method according EX101, wherein the slurry is put inside a casting box to be casted by a casting knife on a moving conveyor to create a continuous sheet.

EX103. A weakened sheet of aerosol-generating substrate, wherein said sheet is weakened through the device of EX1 or of any of EX6 to EX102 or through the method of EX2 or of any of EX73 to EX102.

EX104. The weakened sheet of aerosol-generating substrate of EX103, having weakened portions and un-weakened bands, wherein the un-weakened bands cross each other.

EX105. The weakened sheet of aerosol-generating substrate of EX104, wherein the un-weakened bands are created by the at least one first interruption band and by the at least one second interruption band of the device.

EX106. The weakened sheet of aerosol-generating substrate of EX104 or EX105, wherein the weakened portions are created by areas of the first radial outer face provided with the plurality of first circumferential ridges and the plurality of first circumferential grooves and by areas of the second radial outer face provided with the plurality of second circumferential ridges and the plurality of second circumferential grooves.

EX107. The weakened sheet of aerosol-generating substrate of any of EX104 to EX106, wherein the weakened portions are crimped portions.

EX108. The weakened sheet of aerosol-generating substrate of any of EX104 to EX107, wherein the un-weakened bands are un-crimped portions.

EX.109. The device according to EX10 to EX15, the at least one first interruption band and the at least one second interruption band are skewed concordantly, that is, in the same direction, optionally of a same angle (α=α′) or of a different angle (α≠α′).

EX.110 The device according to EX10 to EX15, the at least one first interruption band and the at least one second interruption band are skewed discordantly, that is, in opposite directions, of different angles (α≠α′).

Examples will now be further described with reference to the figures in which:

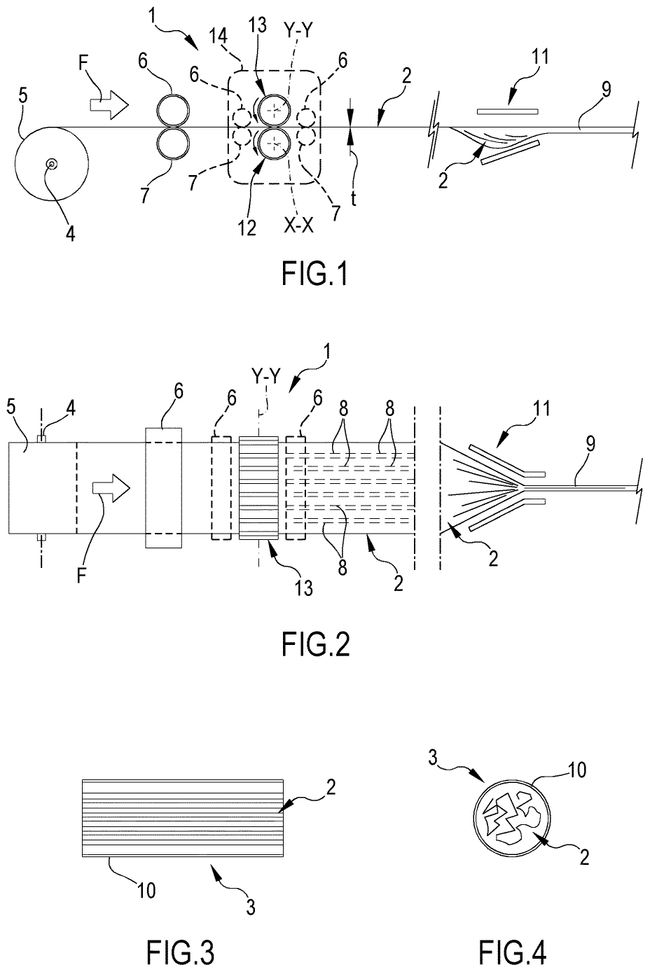

FIG. 1 shows a schematic side view of a portion of an apparatus for manufacturing aerosol-generating article components comprising a device for weakening a sheet of aerosol-generating substrate for an aerosol-generating article component according to the invention;

FIG. 2 shows a top view of the portion of FIG. 1;

FIG. 3 shows a longitudinal section of an aerosol-generating article component manufactured through the apparatus of FIGS. 1 and 2;

FIG. 4 shows a cross section of the aerosol-generating article component of FIG. 3;

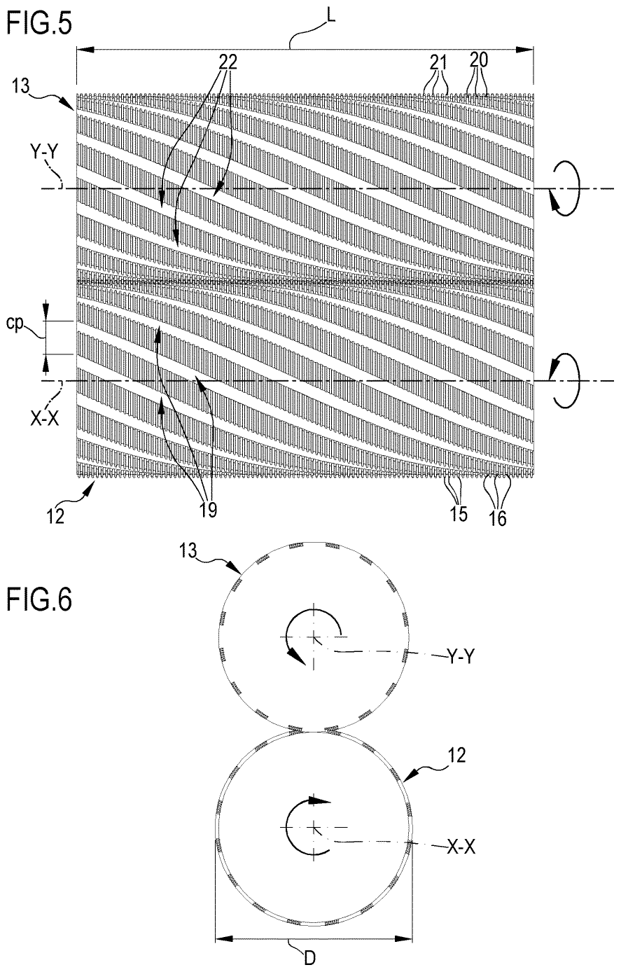

FIG. 5 is a front view of rollers of the device of FIGS. 1 and 2;

FIG. 6 is a side view of the rollers of FIG. 5;

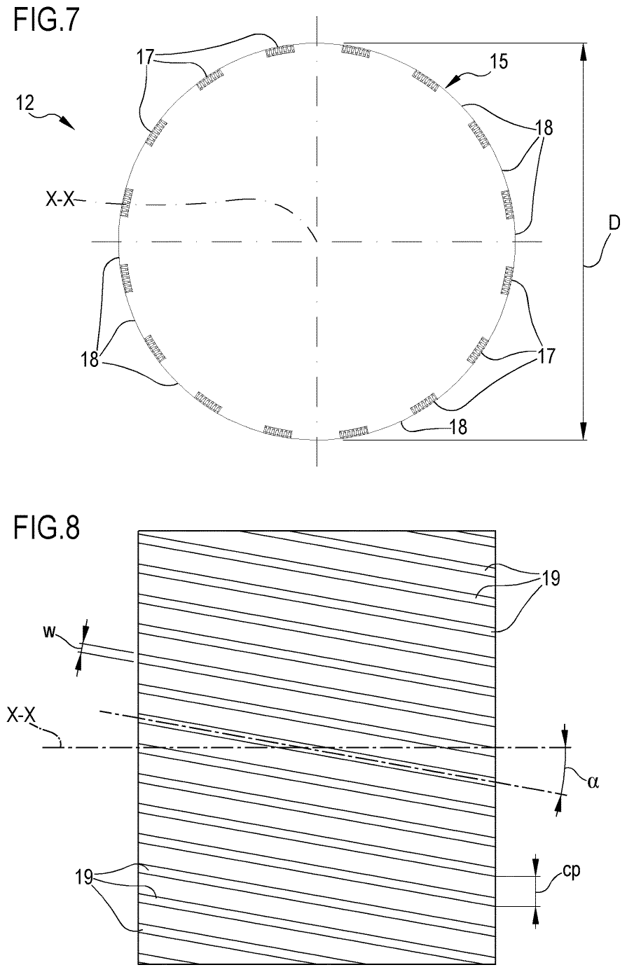

FIG. 7 is an enlarged side view of one of the rollers of FIG. 6;

FIG. 8 shows the cylindrical radial outer face of one of the rollers flattened on a plane;

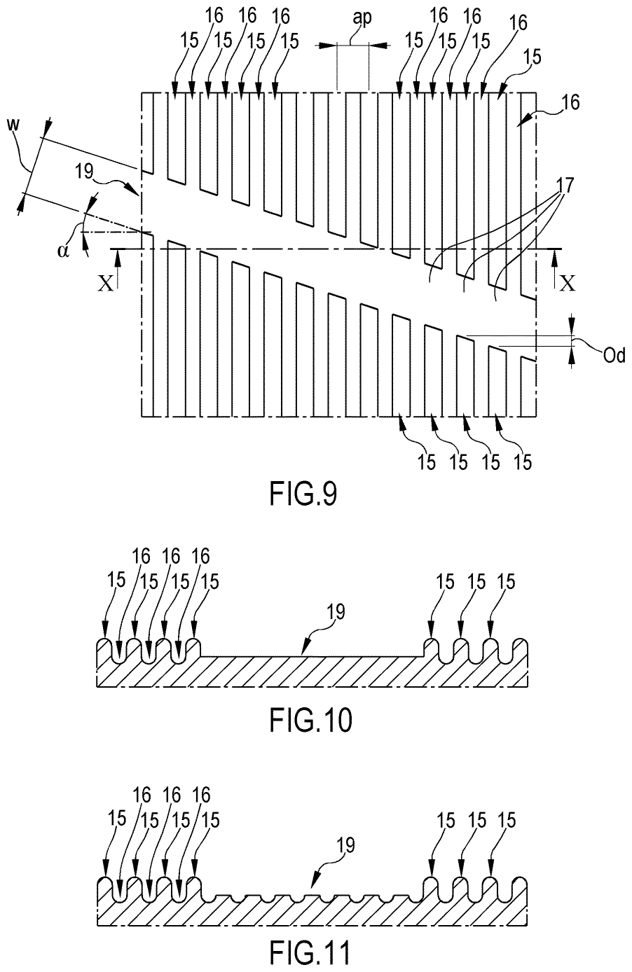

FIG. 9 is an enlarged front view of a part of one of the rollers of FIG. 5;

FIG. 10 is a section view according to plane IX-IX of FIG. 9;

FIG. 11 shows the section view FIG. 10 according to a variant embodiment;

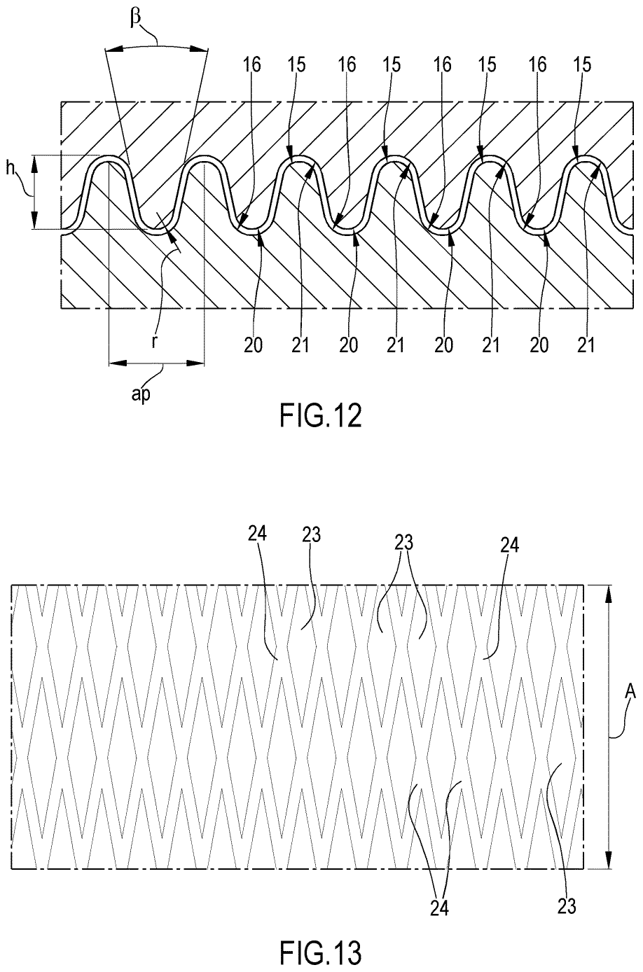

FIG. 12 is an enlarged sectioned front view of a coupling zone of the rollers of FIG. 5;

FIG. 13 is a sheet of aerosol-generating substrate processed through the device of the preceding Figures.

The device 1 shown in FIGS. 1 and 2 is configured for weakening a sheet 2 of aerosol-generating substrate for an aerosol-generating article component 3. The device 1 is part of an apparatus for manufacturing aerosol-generating article components 3 and the apparatus is partially represented in FIGS. 1 and 2.

An aerosol-generating article usually comprises an aerosol-generating article component 3 comprising the aerosol-generating substrate and a filter with a mouthpiece end.

In the aerosol-generating articles, the aerosol is generated by the transfer of heat from a heat source to the physically separate aerosol-generating substrate, which may be located in contact with, within, around, or downstream of the heat source. During use of the aerosol-generating article, the volatile compounds are released from the aerosol-generating substrate by heat transfer from the heat source and are entrained in air drawn through the aerosol-generating article.

The aerosol-generating article component 3 is realized by manufacturing the sheet 2 of aerosol-generating substrate, weakening the sheet 2 of aerosol-generating substrate as will be explained further on, gathering the sheet 2 of aerosol-generating substrate to form a continuous rod and cutting the continuous rod into a plurality of aerosol-generating article components 3 each having a rod shape. The weakening process is helpful for folding and gathering the sheet 2 of aerosol-generating substrate into the rods that will fit into the aerosol generating articles. The aerosol-generating article component 3 comprises therefore a gathered weakened sheet formed from a cut portion of the weakened sheet 2 of aerosol-generating substrate.

The apparatus for manufacturing aerosol-generating article components 3 comprises a reel holder 4 carrying the sheet 2 of aerosol-generating substrate for an aerosol-generating article component. The sheet 2 of aerosol-generating substrate, previously manufactured, is coiled in a bobbin 5 installed on the reel holder 4. The sheet 2 of aerosol-generating substrate unwound from the bobbin 5 is fed along a feeding path in a feeding direction “F”.

Downstream of the reel holder 4, with respect to the feeding direction “F”, the apparatus comprises an upper lamination roller 6 and lower lamination roller 7. The upper lamination roller 6 and lower lamination roller 7 rotate about respective two parallel axis. Peripheral surfaces of the upper lamination roller 6 and lower lamination roller 7 are placed close each other to delimit a gap. The sheet 2 of aerosol-generating substrate unwound from the bobbin 5 passes through said gap where the upper lamination roller 6 and lower lamination roller 7 are configured to compact the sheet 2, to decrease its thickness and to smoothen the surfaces of sheet 2 in order to ensure that its thickness remains symmetric during and after the following steps.

Downstream of the upper lamination roller 6 and lower lamination roller 7, with respect to the feeding direction “F”, the apparatus comprises the device 1 for weakening the sheet 2 of aerosol-generating substrate. The device 1 is a crimping device configured for making a plurality of longitudinal pleats or creases 8 in the sheet 2 of aerosol-generating substrate in order to define longitudinal folding lines to facilitate folding and gathering of the sheet 2 of aerosol-generating substrate to form a rod 9 (FIGS. 1 and 2). The rod 9 may be wrapped in a wrapper 10 and cut in a plurality of aerosol-generating article components 3 (FIGS. 3 and 4).

FIGS. 1 and 2 show schematically a folding device 11 placed downstream of the device 1 for weakening the sheet 2 of aerosol-generating substrate and configured to move the sheet 2 from a flat configuration (upstream of the folding device 11) to a gathered rod-shaped configuration (downstream of the folding device 11) and to wrap the wrapper 10 around the gathered sheet 2. The folding device 11 may be shaped like a tapered funnel.

The device 1 for weakening the sheet 2 of aerosol-generating substrate comprises a first roller 12 configured to rotate about a first rotation axis “X-X” and a second roller 13 configured to rotate about a second rotation axis “Y-Y”. The first roller 12 and the second roller 13 are mounted on a frame 14 (schematically represented in FIG. 1) such that they are allowed to rotate about the respective first rotation axis “X-X” and second rotation axis “Y-Y” and are operationally connected to a motor, not shown, configured to rotate them about said first and second rotation axes “X-X”, “Y-Y”.

The device 1 for weakening the sheet 2 of aerosol-generating substrate comprises a first roller 12 configured to rotate about a first rotation axis “X-X” and a second roller 13 configured to rotate about a second rotation axis “Y-Y”. The first roller 12 and the second roller 13 are mounted on a frame 14 (schematically represented in FIG. 1) such that they are allowed to rotate about the respective first rotation axis “X-X” and second rotation axis “Y-Y” and are operationally connected to a motor, not shown, configured to rotate them about said first and second rotation axes “X-X”. “Y-Y” and in opposite directions.

As depicted in dashed lines in FIGS. 1 and 2, the upper lamination roller 6 and the lower lamination roller 7 may be placed just upstream and/or downstream of the first roller 12 and second roller 13 of the device 1 and may be mounted on the same frame 14.

The first roller 12 comprises a plurality of first circumferential ridges 15 provided on a first radial outer face of said first roller 12 and delimiting a respective plurality of first circumferential grooves 16 on the first radial outer face (FIGS. 5, 7-11).

The radial outer face of the first roller 12 has a cylindrical shape and each of the first circumferential ridges 15 is shaped like a circular ring that surrounds the radial outer face and protrudes radially from said radial outer face. Each first circumferential groove 16 is annular and is delimited between two first circumferential ridges 15. The first rotation axis “X-X” passes through a centre of each first circumferential ridge 15 and each first circumferential groove 16.

As better shown in FIGS. 7 and 9, each first circumferential ridge 15 comprises a plurality of circumferential recesses 17 which are circumferentially spaced from each other along said first circumferential ridge 15 and a plurality of elevations 18 are delimited between the circumferential recesses 17. Each circumferential recess 17 is spaced from another circumferential recess 17 by one elevation 18. A top portion of each elevation 18 defines a portion of the radially outermost surface of the first roller 12 and is shaped like an arch of circumference having a maximum diameter “D” and having its centre in the first rotation axis “X-X”.

The circumferential recesses 17 of one first circumferential ridge 15 are circumferentially offset with respect to the circumferential recesses 17 of two first circumferential ridges 15 contiguous to the one first circumferential ridge 15. Moving along the first rotation axis “X-X” in one direction (for instance from left to right looking at FIGS. 5 and 8), the circumferential recesses 17 of each first circumferential ridge 15 are circumferentially offset with respect to a preceding first circumferential ridge 15 always in a same direction (clockwise or counter-clockwise) of an offset distance “Od”.

The circumferential recesses 17 of the plurality of first circumferential ridges 15 form a plurality of first interruption bands 19 on the first radial outer face of the first roller 12. For instance, twenty circumferential recesses 17 are fashioned on each first circumferential ridge 15 and twenty first interruption bands 19 are fashioned on the first radial outer face of the first roller 12.

In the depicted embodiments, the first interruption bands 19 are skew with respect to the first rotation axis “X-X” and are circumferentially evenly spaced on the first radial outer face. Considering the first radial outer face flattened on a plane (i.e. the cylindrical first radial outer face is virtually unrolled until it is flat on the development plane, like in FIG. 8), the interruption bands 19 delimits with the first rotation axis “X-X” an angle (α) of 20°.

In the embodiment shown in FIGS. 7, 8, 9 and 10, each first interruption band 19 is un-corrugated and smooth, i.e. it is not provided with any circumferential ridge or groove, and is flush with the bottoms of the first circumferential grooves 16.

In the variant embodiment of FIG. 11, each first interruption band 19 is provided with circumferential ridges and grooves but the ridges in each first interruption band 19 have a radial height less than a radial eight of the first circumferential ridges 15 (less corrugated).

The first radial outer face of the first roller 12 comprises therefore an area provided with the plurality of first circumferential ridges 15 and the plurality of first circumferential grooves 16 and an area which is the sum of areas of the first interruption bands 19. The area of the first interruption bands 19 is for instance 40000 mm². The area with the plurality of first circumferential ridges and the plurality of first circumferential grooves is for instance 180000 mm². A ratio of the area of the first interruption bands 19 to the area with the plurality of first circumferential ridges and the plurality of first circumferential grooves is for instance 0.22.

The second roller 13 of the illustrated embodiment is identical to the first roller 12, meaning that shapes and sizes of the first circumferential ridges 15 and of the first circumferential grooves 16 are identical to shapes and sizes of second circumferential ridges 20 and of second circumferential grooves 21 of the second roller 13. Shapes, sizes and number of the first interruption bands 19 are identical to shapes and sizes of second interruption bands 22 of the second roller 13. In a cross section including the first rotation axis “X-X” and a second rotation axis “Y-Y” of the second roller 13, the first circumferential ridges 15 have a shape complementary to a shape of the second circumferential grooves 21 and the second circumferential ridges 20 have a shape complementary to a shape of the first circumferential grooves 16. Both the first circumferential ridges 15 and the second circumferential ridges 20 have wavy and rounded outlines.

FIGS. 9, 10 and 11 show the outlines of the first circumferential ridges 15 and first circumferential grooves 16. FIG. 12 shows a coupling zone of the first roller 12 with the second roller 13 and shows that the first roller 12 and the second roller 13 are identical and axially shifted to allow the first circumferential ridges 15 to be partially inserted in the second circumferential grooves 21 and the second circumferential ridges 20 to be partially inserted in the first circumferential grooves 16.

The following Table 1 provides ranges of geometric values of the first roller 12 and second roller 13 and of the sheet 2 of aerosol-generating substrate.

TABLE 1

| ap | axial pitch of the first circumferential ridges 15 and of the | 0.5-3.0 | mm |
|---|---|---|---|
| | second circumferential ridges 20 (FIG. 12) | | |
| h | height of the first circumferential ridges 15 and of the | 0.5-2.0 | mm |
| | second circumferential ridges 20 (FIG. 12) | | |
| w | width of the first interruption bands 19 and of the second | 2.0-10.0 | mm |
| | interruption bands 22 (FIGS. 8 and 9) | | |
| cp | circumferential pitch of the first interruption bands 19 and | 10 mm-50 mm | |
| | of the second interruption bands 22 (FIGS. 8 and 9) | | |
| A | width of the sheet 2 (FIG. 13) | 80-250 | mm |
| α, α′ | angle of the first interruption bands 19 and of the second | 2°-25° | |
| | interruption bands 22 (FIGS. 5, 8 and 9) | | |
| β | tapering angle of the first circumferential ridges 15 and of | 15°-65° | |
| | the second circumferential ridges 20 (FIG. 12) | | |
| r | curvature radius of the first circumferential ridges 15 and | 0.1 mm-0.5 mm | |
| | of the second circumferential ridges 20 (FIG. 12) | | |
| D | max diameter of the first circumferential ridges 15 and of | 40-300 | mm |
| | the second circumferential ridges 20 (FIGS. 6 and 7) | | |
| t | thickness of the sheet 2 (FIG. 1) | 0.15-0.25 | mm |
| L | axial length of the first roller 12 and of the second roller | 80-400 | mm |

13 (FIG. 5)

The following Table 2 provides ranges of ratios of the values of Table 1.

TABLE 2

| | | |
|---|---|---|
| ap/t | ratio of axial pitch of the first circumferential ridges 15 and | 2-20 |
| | of the second circumferential ridges 20 to the thickness of | |
| | the sheet 2 | |
| h/t | ratio of the height of the first circumferential ridges 15 and | 2-13 |
| | of the second circumferential ridges 20 to the thickness of | |
| | the sheet 2 | |
| w/t | ratio of width of the first interruption bands 19 and of the | 8-70 |
| | second interruption bands 22 to the thickness of the sheet | |
| | 2 | |
| cp/t | ratio of the circumferential pitch of the first interruption | 40-335 |
| | bands 19 and of the second interruption bands 22 to the | |
| | thickness of the sheet 2 | |
| r/t | ratio of the curvature radius of the first circumferential | 0.4-3.33 |
| | ridges 19 and of the second circumferential ridges 22 to the | |
| | thickness of the sheet 2 | |
| ap/D | ratio of axial pitch of the first circumferential ridges 15 and | 0.0017-0.05 |
| | of the second circumferential ridges 20 to the max diameter | |
| | of the first circumferential ridges 15 and of the second | |
| | circumferential ridges 20 | |
| h/D | ratio of the height of the first circumferential ridges 15 and | 0.0017-0.05 |
| | of the second circumferential ridges 20 to the max diameter | |
| | of the first circumferential ridges 15 and of the second | |
| | circumferential ridges 20 | |
| w/D | ratio of width of the first interruption bands 19 and of the | 0.0067-0.25 |
| | second interruption bands 22 to the max diameter of the | |
| | first circumferential ridges 15 and of the second | |
| | circumferential ridges 20 | |
| cp/D | ratio of the circumferential pitch of the first interruption | 0.033-1.25 |
| | bands 19 and of the second interruption bands 22 to the | |
| | max diameter of the first circumferential ridges 15 and of | |
| | the second circumferential ridges 20 | |
| r/D | ratio of the curvature radius of the first circumferential | 0.0003-0.0125 |
| | ridges 15 and of the second circumferential ridges 20 to the | |
| | max diameter of the first circumferential ridges 15 and of | |
| | the second circumferential ridges 20 | |
| A/L | ratio of width of the sheet 2 to the axial length of the first | 0.2-0.95 |
| | roller 12 and of the second roller 13 | |

In other embodiments, not shown in the appended drawings, the first roller 12 may be different from the second roller 13. For instance, shapes and/or sizes of the first circumferential ridges 15 and of the first circumferential grooves 16 are different from shapes and/or sizes of the second circumferential ridges 20 and of the second circumferential grooves 21. For instance, shapes and/or sizes and/or number of the first interruption bands 19 are different from shapes and/or sizes and/or number of the second interruption bands 22.

The first roller 12 and the second roller 13 are mounted on the frame 14 such that the first axis “X-X” of the first roller 12 and the second axis “Y-Y” of the second roller 13 are parallel to each other, the first roller 12 and the second roller 13 intermeshes at the coupling zone. The motor rotates the first roller 12 and the second roller 13 in opposite directions about the respective first rotation “X-X” axis and second rotation axis “Y-Y”.

Furthermore, the first roller 12 and the second roller 13 are mounted on the frame 14 such that the first interruption bands 19 and the second interruption bands 22, when facing each other at the coupling zone, are crossed with respect to each other. In particular, each first interruption band 19 crosses a plurality of second interruption bands 22 and each second interruption band 22 crosses a plurality of first interruption bands 19.

In the illustrated embodiment in which the first roller 12 and the second roller 13 are identical, this can be achieved if the first interruption bands 19 and the second interruption bands 22 are skewed in the same manner on the first roller 12 and on the second roller 13, as shown in FIG. 5.

In other embodiments, not shown in the appended drawings, the angle (α) of the first interruption bands 19 may be different from the angle (α′) of the second interruption bands 22; anyway, the first interruption bands 19 and the second interruption bands 22, when facing each other at the coupling zone, are crossed with respect to each other. For instance, the first interruption bands 19 are parallel to the first rotation axis “X-X” (i.e. α=0) and the second interruption bands 22 are skew with respect to the second rotation axis “Y-Y” (i.e. α′≠0). For instance, the second interruption bands 22 are parallel to the second rotation axis “X-X” (i.e. α′=0) and the first interruption bands 19 are skew with respect to the first rotation axis “Y-Y” (i.e. α≠0). According to some other embodiments, the first interruption bands 19 and the second interruption bands 22 are skewed discordantly, that is, in opposite directions, and of different angles (α≠α′) such that the first interruption bands 19 and the second interruption bands 22, when facing each other at the coupling zone, are still crossed with respect to each other.

According to a method for weakening a sheet 2 of aerosol-generating substrate for an aerosol-generating article component 3 herein disclosed, said sheet 2 of aerosol-generating substrate is fed between the first roller 12 and the second roller 13 of the device 1 while the first roller 12 and the second roller 13 are rotated in opposite directions as shown in FIGS. 1 and 2.

The following Tables 3, 4 and 5 provide features of an example of sheet 2 of aerosol-generating substrate made of cellulose fibers, carboxymethylcellulose and hydroxypropylmethylcellulose as binder and glycerine as an aerosol forming agent.

TABLE 3

| Ingredients | Dry Weight Basis % |
|---|---|
| Hydroxypropylmethylcellulose (HPMC) | 21.0-24.0 |
| Cellulose fibers | 15.0-20.0 |
| Carboxymethylcellulose (CMC) | 5.0-6.0 |
| Glycerin | 45.0-55.0 |
| Nicotine | 1.0-2.0 |
| Fumaric acid | 1.0-2.0 |

TABLE 4

| | | |
|---|---|---|
| Thickness (t) | 0.15-0.25 | mm |
| Grammage | 100-160 | g/m² |

| | |
|---|---|
| Humidity | 5-10% |

TABLE 5

| Elongation at break in longitudinal | 5.0-7.5 | mm |
|---|---|---|
| direction | | |
| Elongation at break in cross direction | 9.5-12.5 | mm |
| Young's module in longitudinal direction | 5-7 | N/mm |
| Young's module in cross direction | 0.8-1.2 | N/mm |
| Stickiness | 0.0150-0.0165 | N |

Test info for data of Table 5: 25-50 mm rectangular samples are tested at 50 mm/min, i.e. at the strain rate 1/min (0.0167/s). The test starts when 0.5 N is measured. Young's modulus is the slope between the strain 0.001 and 0.002. The stickiness test measures the friction between two sheet layers, i.e., the force required to separate the two sheet layers.

According to other embodiments, instead of glycerine another polyhydric alcohol may be used, for instance triethylene glycol or 1,3-butanediol.

FIG. 13 shows the sheet 2 of aerosol-generating substrate after passing between the first roller 12 and the second roller 13 of the device 1. The weakened sheet 2 of aerosol-generating substrate has weakened portions 23 and un-weakened bands 24. The un-weakened bands 24 cross each other (according to a fish-bone pattern) and the weakened portions 23 have rhombus shapes delimited by the un-weakened bands 24. In the weakened portions 23, the sheet 2 is crimped and provided with parallel ridges or corrugations made by the areas of the first radial outer face provided with the plurality of first circumferential ridges 15 and the plurality of first circumferential grooves 16 and by the areas of the second radial outer face provided with the plurality of second circumferential ridges 20 and the plurality of second circumferential grooves 21. In the un-weakened bands 24, the sheet 2 is un-crimped, i.e. it is flat, and said un-weakened bands 24 are created by the first interruption bands 19 and by the second interruption bands 22.

The inventor verified through tests that the disclosed device and method for weakening the sheet 2 of aerosol-generating substrate above disclosed allow to avoids or reduce the tendency of the material of the sheet 2 to stick and settle on the rollers 12, 13 and to reduce machine stops for cleaning operations of the rollers 12, 13 and/or the time required for each cleaning operation.

The following Tables 6 provides the parameters and the results of the tests. The rollers of the standard device comprises one roller provided with interruptions bands and one roller with no interruptions bands, as disclosed for instance in document EP3609352B1.

TABLE 6

| | Test 1 | | Test 2 | |
|---|---|---|---|---|
| | Standard device | | Device here disclosed | |
| Rollers running speed | 120 | m/min | 200 | m/min |
| Tension value on the sheet | 12-14 | N | 5 | N |
| Run time between stops | 1-2 | min | 25 | min |
| Stop time for cleaning | 10-15 | min | 1-2 | min |

As shown in the above test, in order to use the standard device with the conventional crimping rollers configuration (i.e. like EP3609352B1) to process the sheet of aerosol-generating substrate disclosed above (Test 1), a high tension on the sheet (12-14 N) is required to limit its stickiness on the rollers. The high tension can cause quality issues on the final product. Indeed, after this high tensioning, the sheet tries to recover its initial length (the material shows an elastic behavior) and the rods after cut tend to contract and leave both ends with less material. In addition, the high tension can also adversely compromise the crimping effect made on the sheet. Furthermore, with the standard device, the speed must be decreased (120 m/min) and the machine has to be stopped frequently (1-2 min) and kept stopped for a long time (10-15 min) for cleaning operations. Productivity is then reduced.

Conversely, by using the device herein disclosed (Test 2), the machine running speed is higher (200 m/min) and the required tension is much lower than the Test 1. The machine can run much longer time without a stop and each stop time is limited (1-2 min).

Another example of sheet 2 of aerosol-generating substrate to be processed through the device 1 may be a cast leaf, such as tobacco cast leaf. The cast leaf is obtained through a casting process from ingredients such as tobacco powder or other nicotine containing materials, water, fibers, for instance cellulose, glycerin, guar. A first step is the manufacturing of a tobacco slurry by mixing the above ingredients. The slurry is a watery mixture of insoluble matter with a water content of 70 percent-80 percent. In a second step, the slurry is put inside a casting box to be casted by a casting knife on a moving conveyor steel belt to create a continuous sheet.

The inventor found that processing the cast leaf through the device 1 allows to crimp the sheet without shredding the material creating the so called “spaghetti” effect. This is because the fish-bone pattern on the sheet 2 generated by the first interruption bands 19 and the second interruption bands 22 avoids breakage of the material once crimped.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5 percent of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A device for weakening a sheet of aerosol-generating substrate for an aerosol-generating article component, the device comprising:
a first roller having a first rotation axis and comprising a plurality of first circumferential ridges provided on a first radial outer face of the first roller, the first circumferential ridges delimiting a respective plurality of first circumferential grooves on the first radial outer face, wherein each first circumferential ridge has at least one circumferential recess and the circumferential recesses of the plurality of first circumferential ridges form at least one first interruption band on the first radial outer face; and
a second roller having a second rotation axis and comprising a plurality of second circumferential ridges provided on a second radial outer face of the second roller, the second circumferential ridges delimiting a respective plurality of second circumferential grooves on the second radial outer face, wherein each second circumferential ridge has at least one circumferential recess and the circumferential recesses of the plurality of second circumferential ridges form at least one second interruption band on the second radial outer face;
wherein the first roller and the second roller are configured to rotate in opposite directions about the respective first rotation axis and second rotation axis,
wherein, at a coupling zone of the first roller with the second roller, the first circumferential ridges are partially inserted in the second circumferential grooves and the second circumferential ridges are partially inserted in the first circumferential grooves, and
wherein the at least one first interruption band and the at least one second interruption band, when facing each other at the coupling zone, are crossed with respect to each other.

17. The device according to claim 16,
wherein a ratio of an area of the at least one first interruption band on the first radial outer face to an area of the first radial outer face provided with the plurality of first circumferential ridges and the plurality of first circumferential grooves is between 0.03 and 0.30, and
wherein a ratio of an area of the at least one second interruption band on the second radial outer face to an area of the second radial outer face provided with the plurality of second circumferential ridges and the plurality of second circumferential grooves is between 0.03 and 0.30.

18. The device according to claim 16,
wherein each first circumferential ridge has a plurality of circumferential recesses and the circumferential recesses of the plurality of first circumferential ridges form a plurality of first interruption bands on the first radial outer face,
wherein each second circumferential ridge has a plurality of circumferential recesses and the circumferential recesses of the plurality of second circumferential ridges form a plurality of second interruption bands on the second radial outer face, and
wherein, at the coupling zone of the first roller with the second roller, each first interruption band crosses a plurality of second interruption bands and each second interruption band crosses a plurality of first interruption bands.

19. The device according to claim 16, wherein the at least one first interruption band is parallel to the first rotation axis or the at least one second interruption band is parallel to the second rotation axis.

20. The device according to claim 16,
wherein a ratio of a width (w) of the at least one first interruption band to a thickness (t) of a sheet of aerosol-generating substrate is between 8.0 and 70.0, and
wherein a ratio of a width (w) of the at least one second interruption band to a thickness (t) of a sheet of aerosol-generating substrate is between 8.0 and 70.0.

21. The device according to claim 16, wherein shapes and sizes of the first circumferential ridges and of the first circumferential grooves are identical to shapes and sizes of the second circumferential ridges and of the second circumferential grooves.

22. The device according to claim 16, wherein shapes and sizes of the at least one first interruption band are identical to shapes and sizes of the at least one second interruption band.

23. The device according to claim 16, wherein the first roller and the second roller are identical and axially shifted to allow the first circumferential ridges to be partially inserted in the second circumferential grooves and the second circumferential ridges to be partially inserted in the first circumferential grooves.

24. A method for weakening a sheet of aerosol-generating substrate for an aerosol-generating article component, the method comprising:
feeding a sheet of aerosol-generating substrate between the first roller and the second roller of the device according to claim 16 while the first roller and the second roller rotate in opposite directions.

25. The method according to claim 24, wherein the sheet of aerosol-generating substrate is a fiber-based substrate having an elongation at break in a longitudinal direction between 5.0 mm and 7.5 mm and an elongation at break in a cross direction between 9.5 mm and 12.5 mm.

26. The method according to claim 24, wherein the sheet of aerosol-generating substrate has a Young's modulus in the longitudinal direction between 5 N/mm and 7 N/mm and a Young's modulus in the cross direction between 0.8 N/mm and 1.2 N/mm.

27. The method according to claim 24,
wherein the sheet of aerosol-generating substrate is made from a mixture comprising cellulose fibers, a binder, and an aerosol-forming agent,
wherein the fibers are cellulose fibers,
wherein the binder comprises a derivative of cellulose,
wherein the aerosol-forming agent is a polyhydric alcohol,
wherein an amount of the fibers in the mixture is 15.0 percent to 20.0 percent on dry weight basis,
wherein an amount of the binder in the mixture is 28.0 percent to 30.0 percent on dry weight basis, and
wherein an amount of the aerosol forming agent in the mixture is 45.0 percent to 55.0 percent on dry weight basis.

28. The method according to claim 27,
wherein the derivative of cellulose comprises carboxymethylcellulose and hydroxypropylmethylcellulose,
wherein an amount of the carboxymethylcellulose in the mixture is 5.0 percent to 6.0 percent on dry weight basis, and
wherein an amount of the hydroxypropylmethylcellulose in the mixture is 21.0 percent to 24.0 percent on dry weight basis.

29. A sheet of aerosol-generating substrate weakened through the method according to claim 24, wherein the sheet of aerosol-generating substrate has weakened portions and un-weakened bands, and wherein the un-weakened bands cross each other.

30. A process for manufacturing an aerosol-generating article component, the process comprising the following steps:
manufacturing a sheet of aerosol-generating substrate;
weakening the sheet of aerosol-generating substrate through the method according to claim 24;
gathering the sheet of aerosol-generating substrate to form a continuous rod; and
cutting the continuous rod into a plurality of aerosol-generating article components each having a rod shape, each aerosol-generating article component comprising a gathered weakened sheet formed from a cut portion of the weakened sheet of aerosol-generating substrate.
